(19) United States
(12) Patent Application Publication
(10) Pub. No.: US 2016/0305123 A1
(43) Pub. Date: Oct. 20, 2016

(54) INTEGRAL ARQUITECTURAL MODULAR HOUSE ASSEMBLY AND FABRICATION SYSTEM WITH INTERCONNECTING UNIVERSAL WALLS AND UNIVERSAL CONNECTORS AND UNIVERSAL ROOF PIECES

(71) Applicant: Juan Fernando LJUBICIC RUBIO, Lima (PE)

(72) Inventor: JUAN FERNANDO LJUBICIC RUBIO, Lima (PE)

(21) Appl. No.: 15/024,741

(22) PCT Filed: May 21, 2014
(86) PCT No.: PCT/PE2014/000007

§ 371 Date: Mar. 24, 2016

(30) Foreign Application Priority Data
May 21, 2013 (PE) 001233-2013/DIN

(51) Int. Cl. E04C 2/52; E04B 5/02; H01R 24/76; E04B 1/343; H01R 24/66; E04B 2/00; E04H 1/00

(52) U.S. Cl. CPC E04C 2/521; E04C 2/46; E04C 2/50; E04C 2/526; E04H 1/005; E04B 1/34321; H01R 24/66; H01R 24/76; H01R 2103/00

(57) ABSTRACT

This system has achieved in making unique pieces in order to generalize the construction of buildings by simplifying the construction process to the manufacture of three (3) products, to achieve our modular house models.

This simplification in the manufacture process results in the simplification of the infrastructure of the installed plant capacity.

### TECHNICAL FIELD

The technical field which deals with the present invention is about prefabricated buildings, specifically the ones referred to modular type constructions.

### STATE OF THE ART

The following techniques described in this document differ from the conventional prefabricated construction techniques, where the conventional prefabricated constructions do not manufacture walls, instead, they are manufactured (in situ) from (prefabricated) simple panels, which require first completing the exterior structure, then the power current installation and the placement of doors and windows, resulting into additional operations and costs, considering that these constructions also are subject to individual client's designs, translating into individual initiation and operation costs, while this alternative system, is based on predetermined modular house, which represents the core invention, since these models are created on the basis of three (3) related inventions, which results in simplifying dozens of processes or maybe more, of a typical construction. In the manufacture of these three (3) interrelated basic inventions with which, the predetermined models hereunder presented, were finally developed. These three (3) basic inventions possess unique claim characteristics, which achieve an unequaled simplicity in the construction of prefabricated houses, result in savings in operation costs resulting in a very low cost and price. This document describes a “UNIT OF INVENTION”.

### “UNIT OF INVENTION” DESCRIPTION

The following invention consists in the integral manufacture of various predetermined house models in bases of WALLS, CONNECTORS and ROOF COMPONENTS completely equal one to the other, in order to optimize the process.

This means, that with three (3) types of sub-products, we can build a house. This does not imply that in some punctual cases, some unnecessary details may be omitted, which simplify even more the manufacturing process of these three (3) basic elements; inventions in their own right.

This system achieves two important things: First the setup of a very simple factory, since only three (3) elements need to be manufactured, making the initial capital investment much smaller than what it would normally be, and second optimizing a house construction process and cost operation into a house manufacturing process and cost operation. (very important), meaning that with this integral system, the construction processes are replaced with manufacturing processes, optimizing in this way the production capacity, as well as optimizing the production system, and optimizing the products due to the possibility of specialization in the production process. It's worth mentioning that if on one side we have the benefits of serial production just described, on the other we are limited to our plans and to the predetermined requirements of our system of production and manufacture. We want to emphasize that this system finally results in making houses, but for this end, we need to do three (3) semi-products with specific details which are explained hereunder, which are universal and unique in a construction, and each one does not function without the other components, reason why it is called an integral system. It is very important to highlight in our application that our system is a group of inventions related to each other, denominated “UNIT OF INVENTION”.

*Adding another virtue to the invention, we are achieving a new standard of quality of life for the low income families thanks to the reduction in operating costs achieved with the Units of Invention.

The three System Elements are three related inventions which are components that make up a principal invention, which are the models shown hereunder.
a) The Universal Wall:

The walls have the distinction to possess all exterior and interior finishing detail, as well as door, window, drain and water circuits, outlet and inlet switches. These walls contain a unique power current circuit in the interior which allows a coincidence with the other walls, as well as when referred to the plumbing circuit.

This wall is a standard piece, which is made so that this same unit can be used for the assembly of various models of modular homes, that is universal standard walls, which can be connected wall with wall, through a universal connector, and always after connecting, it permits the correct functioning of the services (electrical and plumbing) once the installation of the houses is complete. With respect to this last point, this standard universal prefabricated wall contains in a fixed and predetermined position, spaces, openings, electrical and plumbing circuit, as well as switches, sockets, amongst other electrical devices, as well as predetermined positions for doors and windows.

The wall may function with various construction materials, such as the concrete, wood, melamine, plastic, metal amongst others. The universal walls rest in channels placed in the floor which seal and waterproof all of the house perimeter and interior areas, so that once connected these walls form the desired modules according to the predetermined model plans.

All universal walls have in common that the exhibit a 2.40 m high, 3 meters high and 10 cm thickness; and all exhibit the same power, water and drain circuit, ready to be used, or simply circumvent it if not required. The simplification of the dimension and circuits positions is a factor for the lowering the manufacturing operations, for being only one the wall to manufacture and in this way optimize the production speed to the maximum, since it is a universal wall which will be manufactured in series.
b) Universal Wall Connector:

It is constituted by a square tube where each one of the sides have two guides which serve to fasten the “C” channel which finally will hold the wall, and a cover which covers the unused sides. In the top inner part of the connector, are the power current connector “female-ended” which split on all sides and will plug in with the wall connectors “male-ended”.

In the inferior part of the Universal Connector, is a free pass which gives play to the flexible tubes (not rigid) that come out of the wall, for the water connection which is always straight in our designs.

The inner part of the Universal Connector is filled with thermal acoustic material, to insulate the cold/water pass and sound through them.

Finally the cover guides for the sides in disuse, which also function as decorative pieces.

This Universal Connector was created to standardized spaces composed by the Universal Walls by a facilitating their homogeneous placement, and the pass of power, water and other services through them.

In the sides of the Universal Walls are the Universal Connectors, which, as their name indicates serve to connect one Universal Wall with another, at the same time serve to connect the circuits (cables and ducts), in such a way that, when the placement is finished, all circuits of water and drain and light and power switch will be ready to use.

Within our Universal Connector, we have an electric power pass, permitting the necessary current flow to each wall at the moment of installation.

We also have, covers for the sides of the Universal Connector that are not in use, or which are not necessary for the moment until the next house remodeling.

Once connected the light and water and their respective plugs and jacks, we use bolts to bolt in the “C” channel of the Universal Connector with the Universal Wall, in order to secure it in this way.
c) Universal Roof Piece

The roof is a piece with strategic electric current connection points, which coincide symmetrically one with the other with the wall outlet point, which is special for its position and coincidence in all our house models constructed with this system, and which are numbered and shown in our claims and figures. This roof piece, once installed, will have the lights placed and correctly functioning in all of the house, by being in coordination with the spatial distribution of the light switches in all of the Universal Walls, resulting in the correct “off and on” switching of roof lights.

These roof pieces are fastened one to the other with metal plates which serve as leveling pins, to obtain an even and leveled roof , a flat ceiling is seen from the inside of the house, and the view from the outside shows a gable roof, or flat roof without changing the system, it being an obvious detail. In the graphics we appreciate a roof piece where in each extreme, it has a square shape, one smaller than the other, which permits mounting these two extremes, while joining roof blocks from right to left, instead than from bottom end to upper end, in order to achieve a waterproof effect between blocks or roof pieces. Our roof piece is also symmetrical and universal, as the Universal Wall.

This Universal Roof pieces has a hollow interior where the light system of cold light has already been installed, chosen not only for energy savings but also because it offers higher security than conventional systems of light. Each Universal Roof piece has a current inlet and an outlet always in the same site, it has Universal Roof piece to Universal Roof piece auto connectors, as well as Universal Roof piece to Universal Wall direct connections, plugable to one another, always in the same site and position, making thus our roof pieces a Universal Roof pieces, characteristic which is crucial in our system, due to its simplicity and operation savings.

### BRIEF FIGURE DESCRIPTION

We want to make clear that in order to capture explanatory figures in this document, circumscribe the system hereto described, to the materials exposed in certain figures. In this system or unit of invention, no matter what materials are used, what matters is the correct functioning of the system.

FIG. 1: This figures shows the basic wall, without details, of 2.40 mts high and 3.00 mts wide and 10 cm thick.

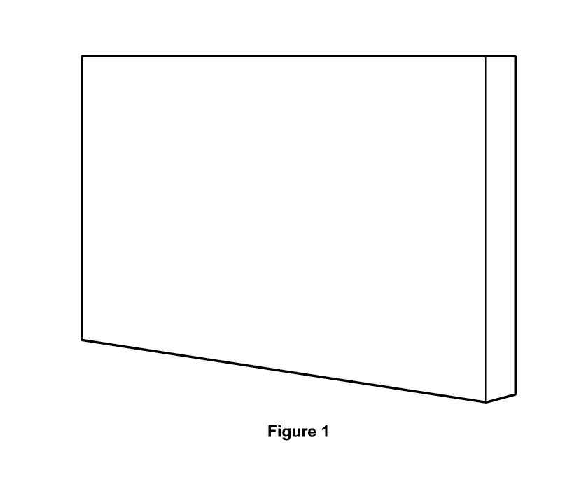

FIG. 2: This figures shows the position of the door, window, power switch, power outlet in each wall, the door and window can be bypassed in case of not being needed, creating savings in specific cases.

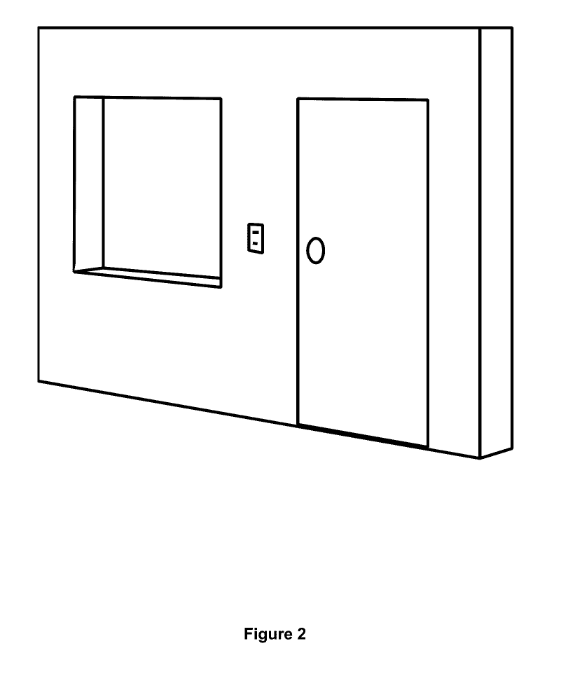

FIG. 3: Power current position links are shown in green (3.1) and water and sewer connection link in blue (3.2).

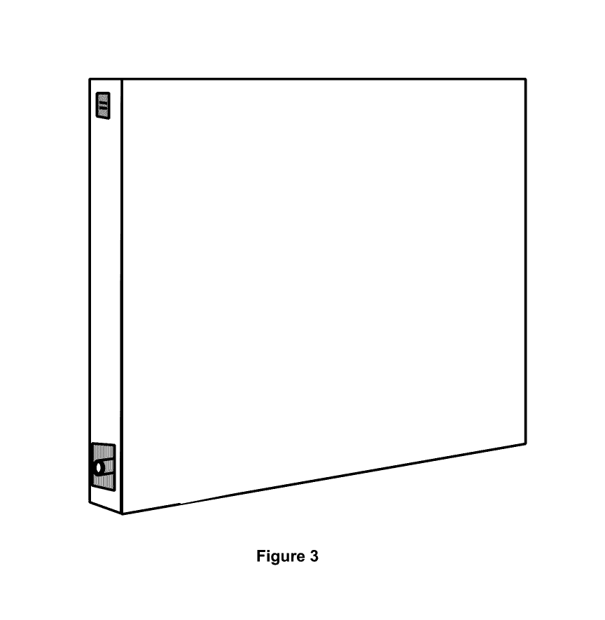

FIG. 4: Another view of the power current and water and sewer links (3.1, 3.2).

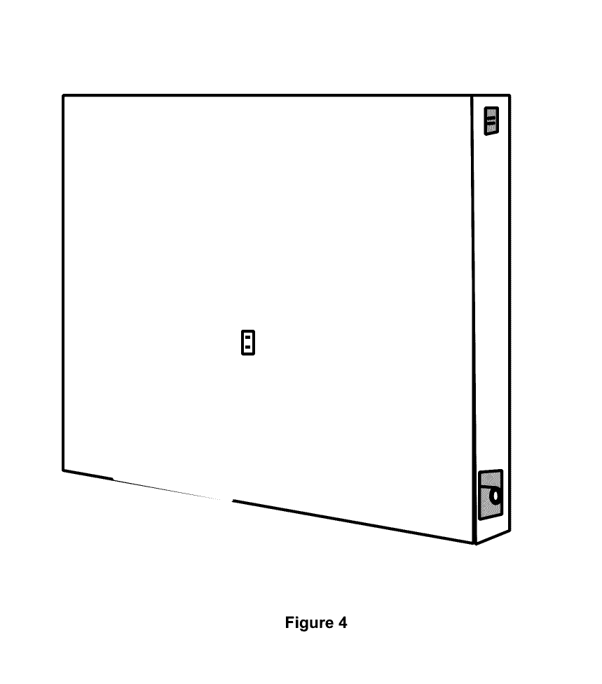

FIG. 5: Lateral view of the wall with water and current links.

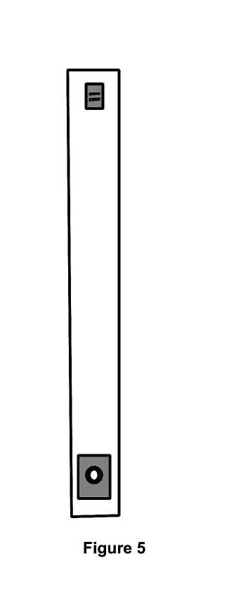

FIG. 6: View in perspective of wall/roof power current links (6.1) and electrical outlet and switch (2.2).

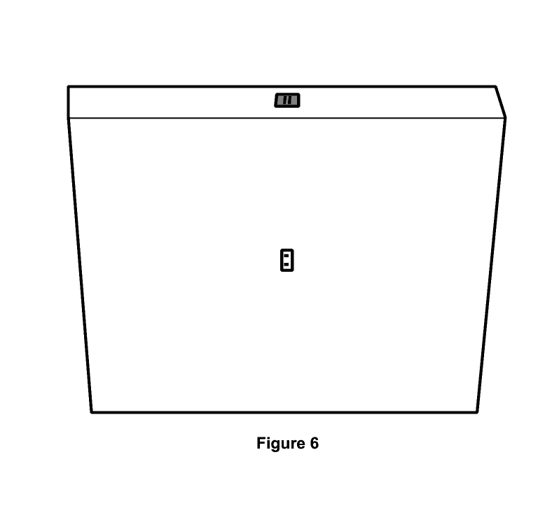

FIG. 7: Possible internal structure of universal wall, not necessarily the only one.

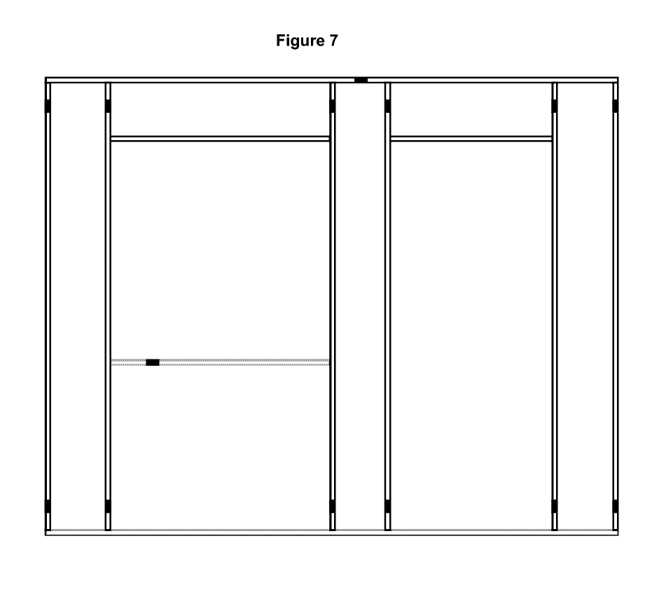

FIG. 8: Shows wall fastening channels.

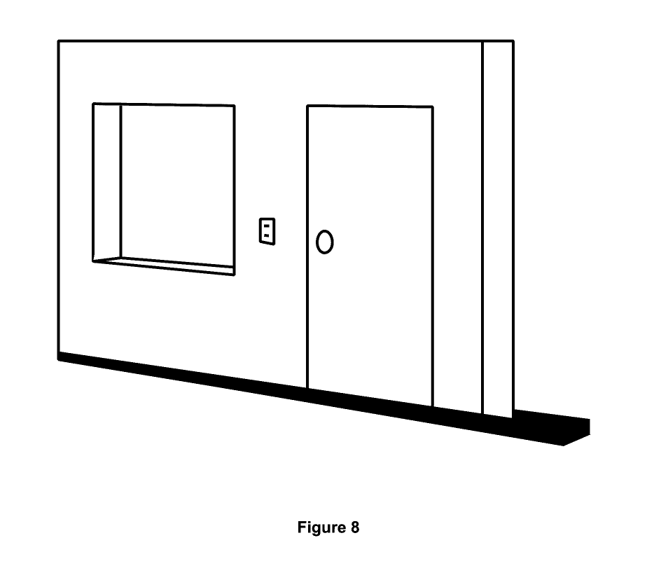

FIG. 9: A possible inner structural distribution of the universal wall, frontal view.

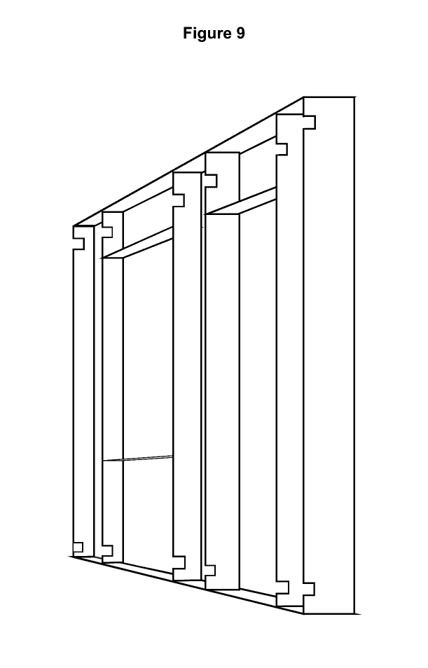

FIG. 10: Electrical distribution of the universal wall.

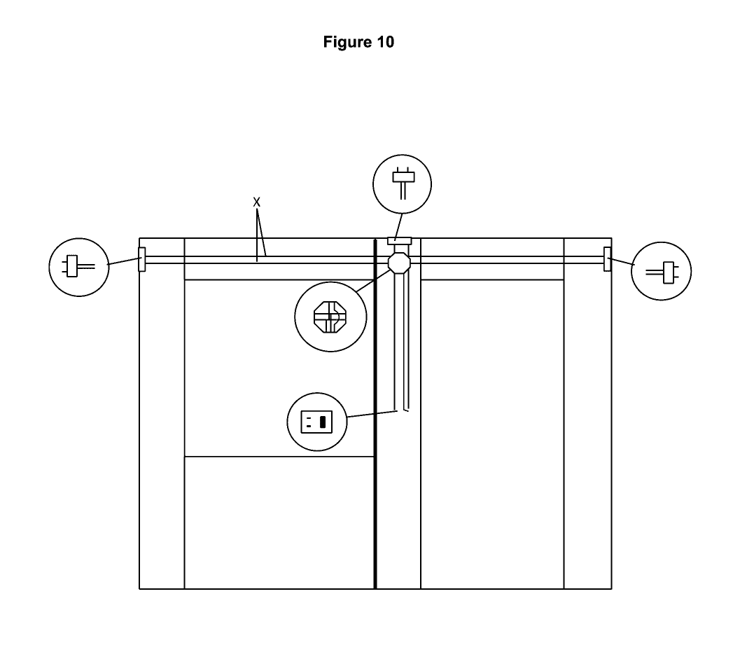

FIG. 11: Wall with water outlets and plumbing network links.

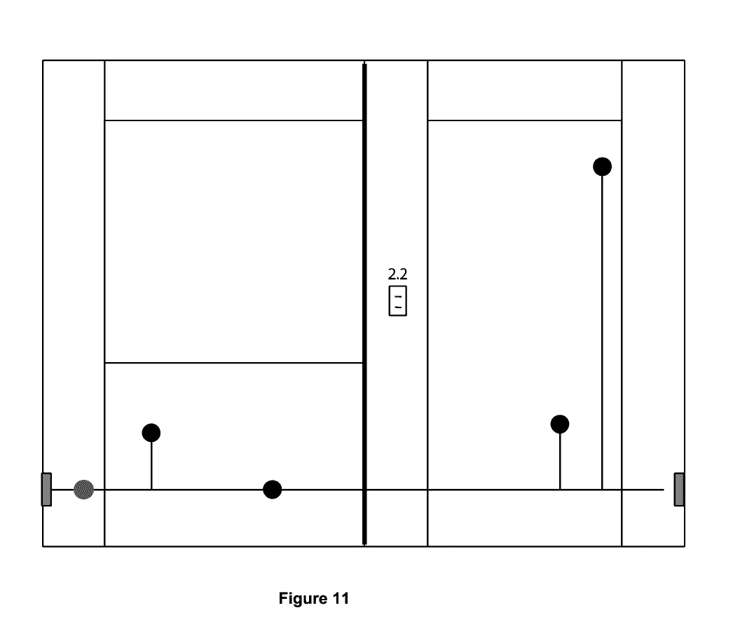

FIG. 12: View in perspective of wall connector with interconnecting channels.

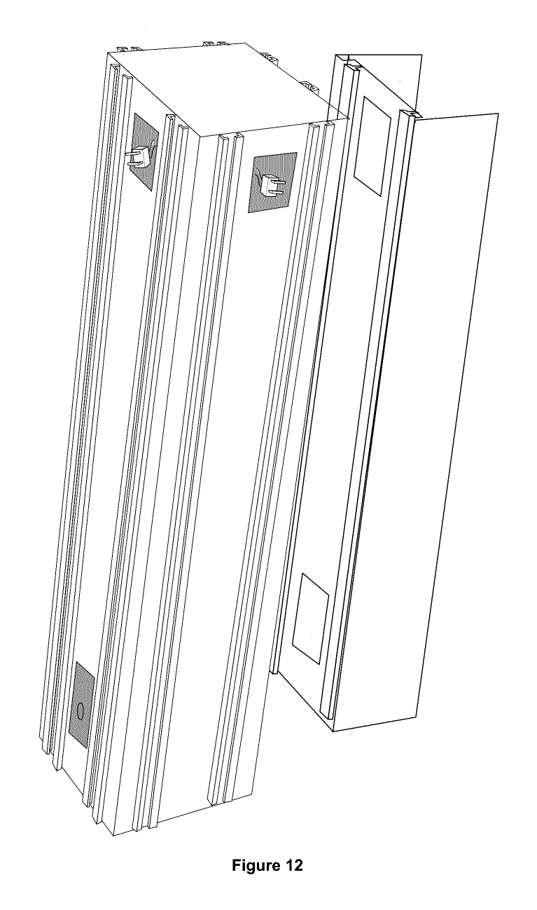

FIG. 13: 3-D view of the “C” channel showing “T” rails, which fit the square tube guides (connector), shown hereunder.

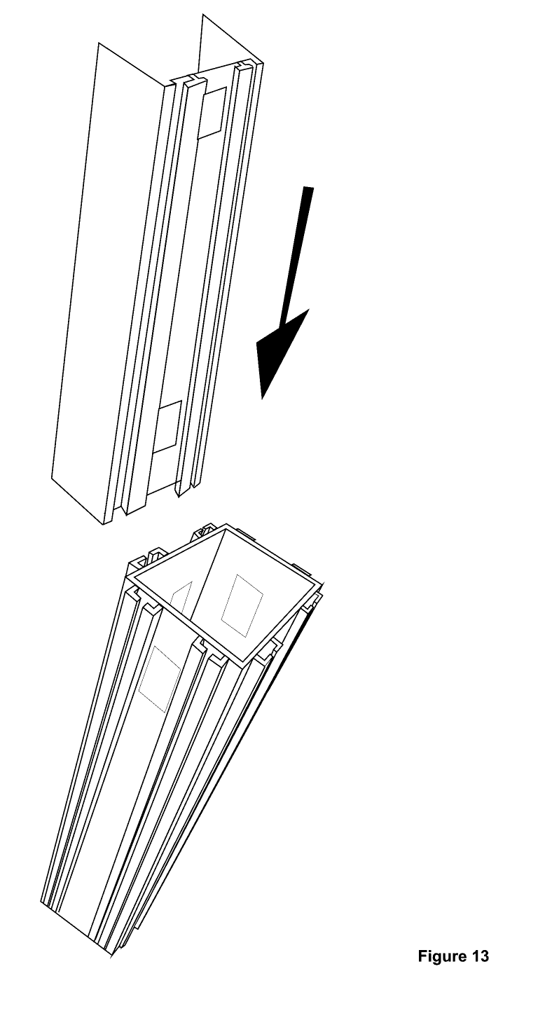

FIG. 14: Plant view with the rails placed and in placement as well.

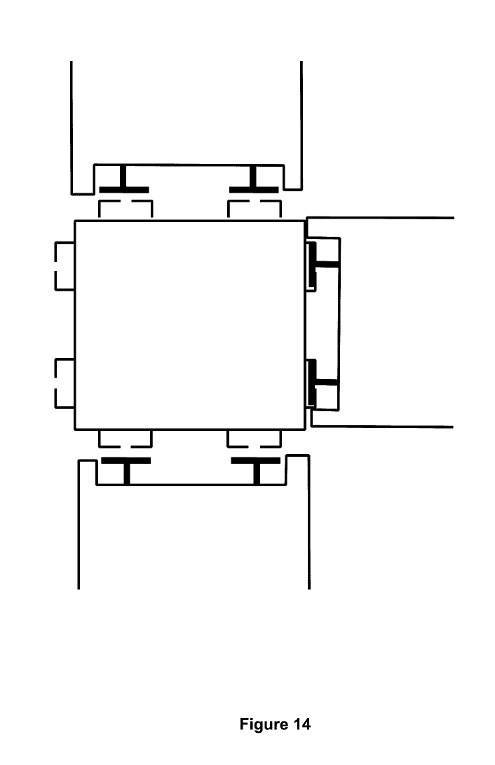

FIG. 15: Perspective view of the decorative cover of the connector.

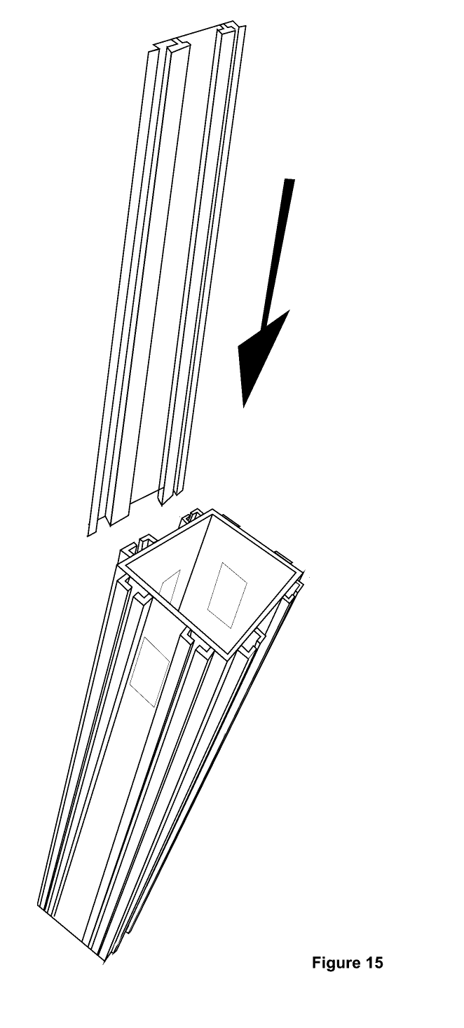

FIG. 16: Explains the positions of the placement of channels, which can be of 2 to 4 used sides.

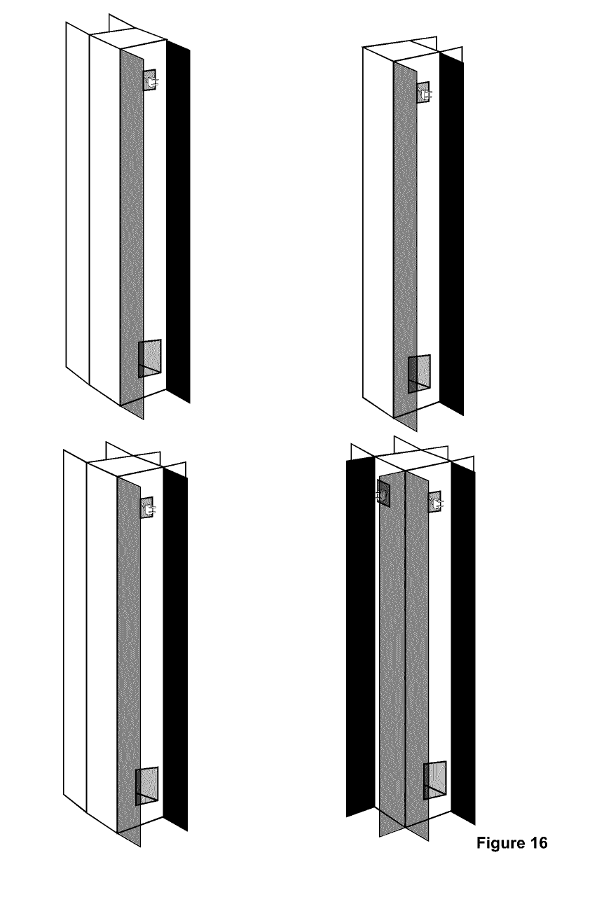

FIG. 17: Sample of a current network distribution for it to be universal.

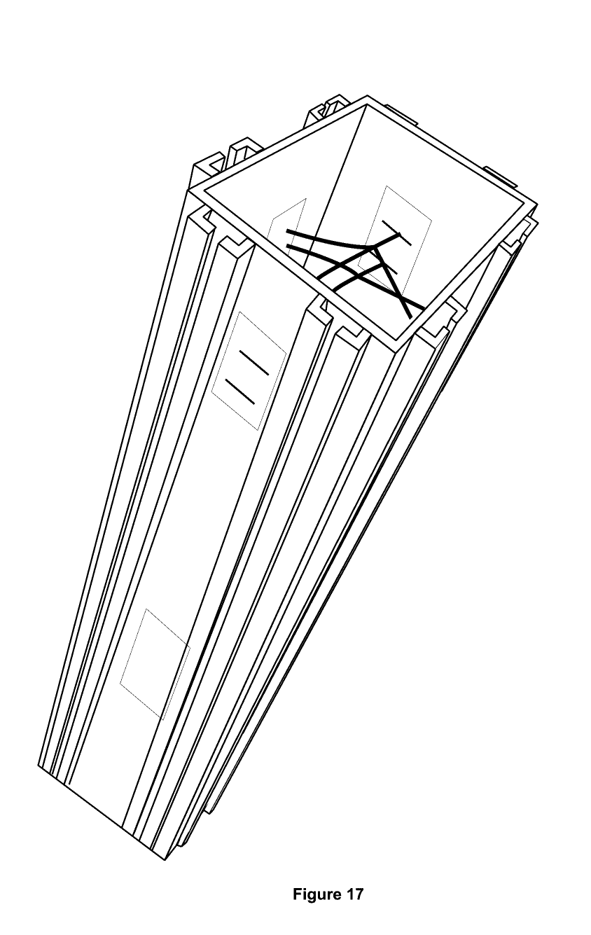

FIG. 18: Plant view of a sample of electric distribution.

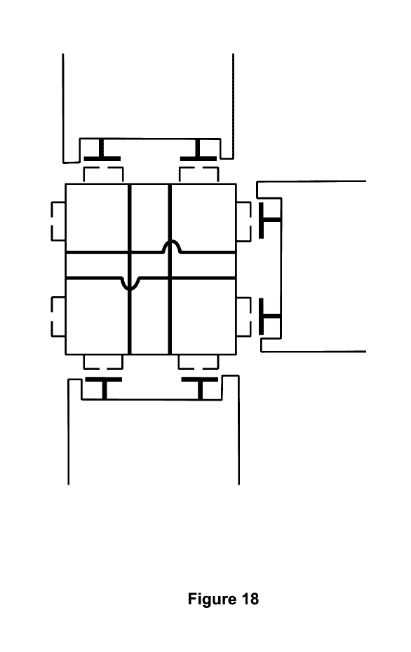

FIG. 19: Sample of connections of wall and floor.

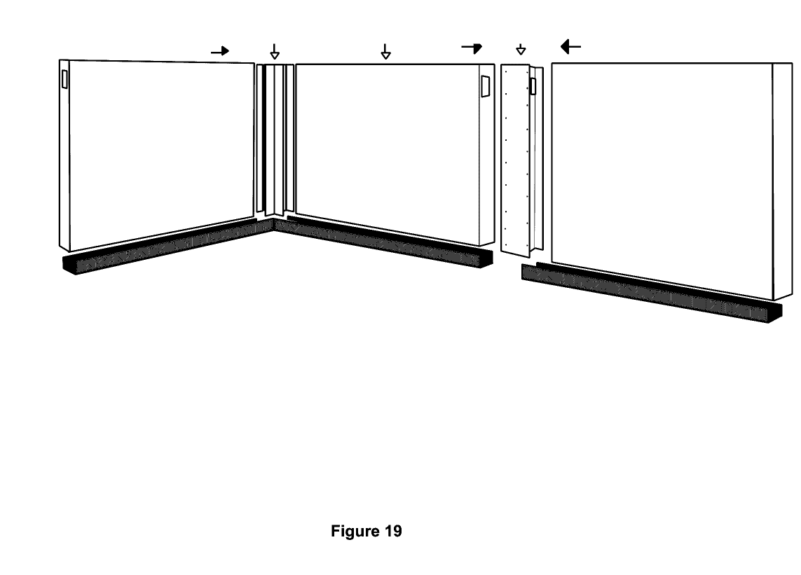

FIG. 20: Sample of roof piece and its structural parts, such as special top structures for right to left coupling, flat support, and a top linking structure.

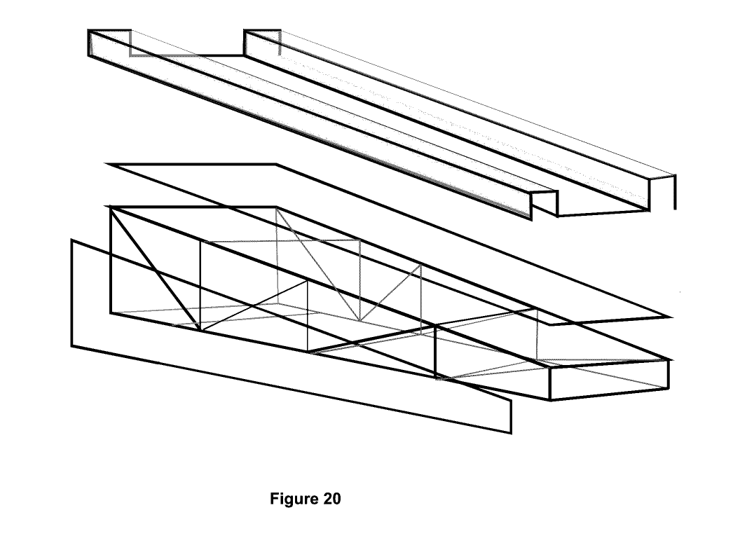

FIG. 21: Sample of electrical current inlet position in the roof piece , unique light position in all pieces and current network.

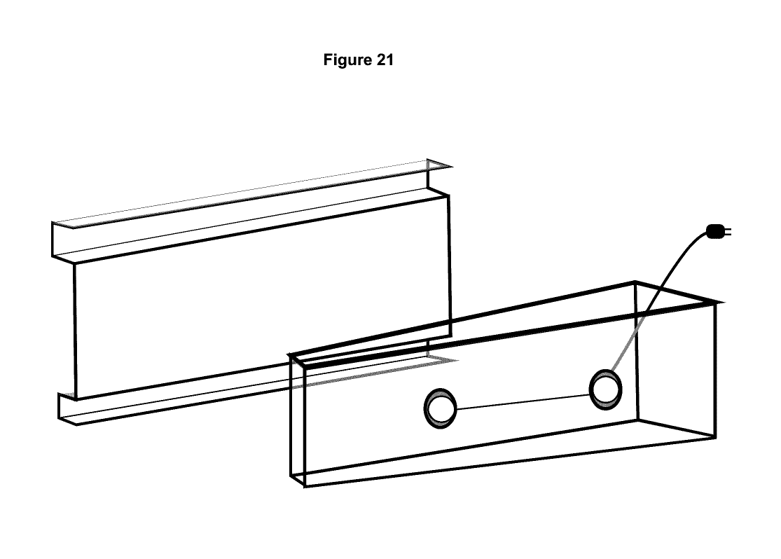

FIG. 22: Another lateral view of the roof piece.

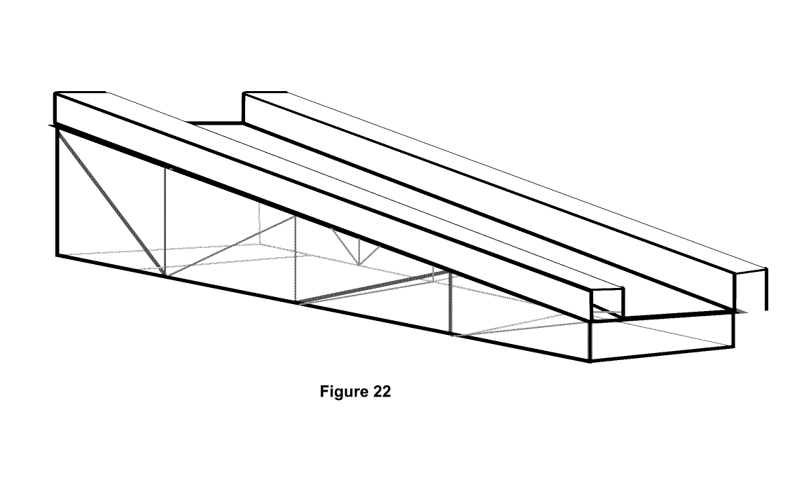

FIG. 23: Depicts special form of coverage, where the left side wraps around the rights side, in such a way as to prevent water leaking; view of three separate roof pieces, ready for right to left coupling.

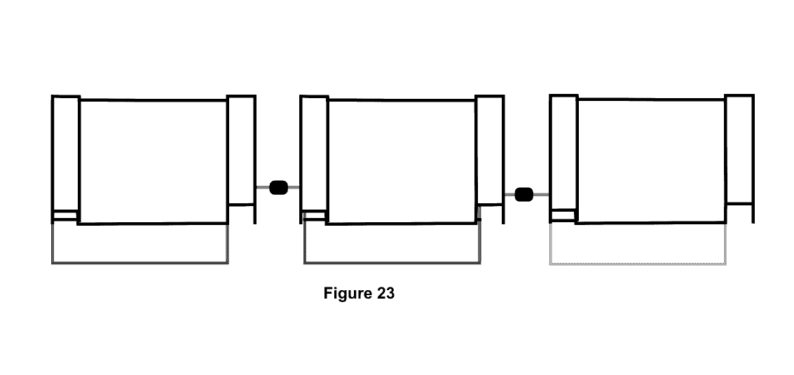

FIG. 24: Top Plant view of the distribution of all the pieces that make up the roof and the fit of the wall and roof connectors.

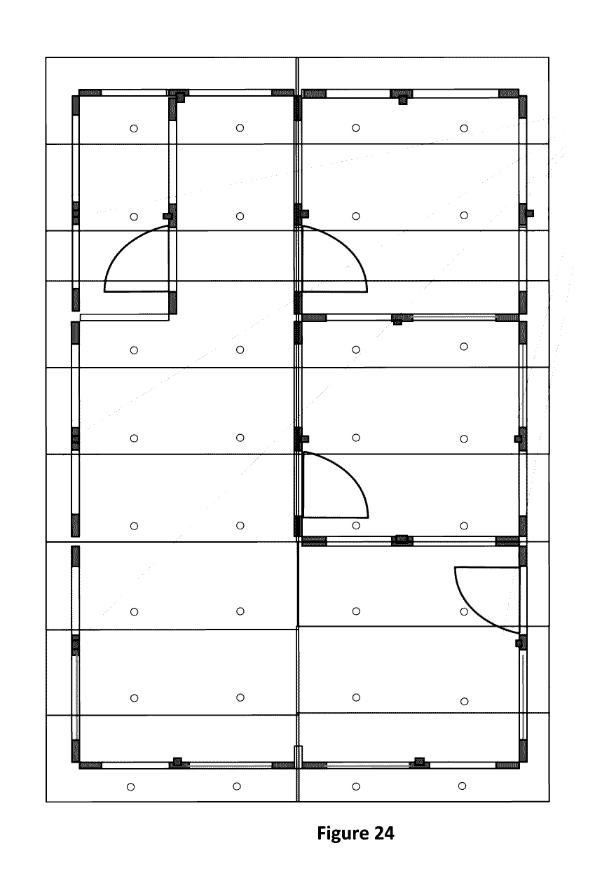

### DETAILED DESCRIPTION OF THE INVENTION

An integral system of assembly and fabrication of architectural modular houses, which simplifies all building construction processes to three basic elements, meaning simplifying the construction of building to a process of building installation, with intelligent and interchangeable walls, which include a) wall with a network for an electrical circuit, plumbing circuit; b) wall to wall connectors which give symmetry and homogeneity to the distributions, a requisite which became indispensable in order to achieve the universality and homogeneity of the basic elements; c) universal roof which make the installation simple and quick.

### a) The Universal Wall

The walls have the distinction to possess all exterior and interior finishing detail, as well as door, window, drain and water circuits, outlet and inlet switches. These walls contain a unique power current circuit in the interior which allows an coincidence with the other walls, as well as when referred to the plumbing circuit.

This wall is a standard piece, which is made so that this same unit can be used for the assembly of various models of modular homes, that is universal standard walls, which can be connected wall with wall, through a universal connector, and always after connecting, it permits the correct functioning of the services (electrical and plumbing) once the installation of the houses is complete. With respect to this last point, this standard universal prefabricated wall contains in a fixed and predetermined position, spaces, openings, electrical and plumbing circuit, as well as switches, sockets, amongst other electrical devices, as well as predetermined positions for doors and windows.

The wall may function with various construction materials, such as the concrete, wood, melamine, plastic, metal amongst others. The universal walls rest in channels placed in the floor which seal and waterproof all of the house perimeter and interior areas, so that once connected these walls form the desired modules according to the predetermined model plans.

All universal walls have in common that the exhibit a 2.40 m high, 3 meters high and 10 cm thickness; and all exhibit the same power, water and drain circuit, ready to be used, or simply circumvent it if not required. The simplification of the dimension and circuits positions is a factor for the lowering the manufacturing operations, for being only one the wall to manufacture and in this way optimize the production speed to the maximum, since it is a universal wall which will be manufactured in series.

### b) The Universal Connector

Conformed by a universal connector (12) which is a structural quadrilateral tube, characterized because in the interior it contains a network of electrical wiring in the top part, and a free bass for plumbing piping in the inferior part, where the connection points in the wall (1) and of coupling and fastening structure of the “C” channel, which holds the wall (1).

Additionally, the connector (12) may rest on channels which are found in the perimeter of the house and interiors for a better alignment, disposition and built of living spaces.

The connector's empty spaces (13) may be filled with thermo-acoustic material, to minimize sound and temperature fluctuations.

The “C” channel (13), is characterized because it supports a wall (1) and facilitates its connection with the connector (12), that is with another wall (1), it has 2 spaces, where the space is found in the top part and permits the pass of the electrical wiring, and the bottom spacing permits the pass of the plumbing circuit; it is characterized as well because it has the channels which are coupled to the guides.

The top cover (15) has an exterior and interior part, where the exterior part is flat and the interior part has channels which couple to the guides.

### c) The Roof Piece

The roof (20) is composed, by pieces which are characterized because they have a universal interior structure which contains the electrical wiring network, and has a linear form, also the top plate of the roof piece has a water fall aligned to the house roof, the structure, is covered by the top and bottom part respectively, for a better finishing and to cover more effectively the structure. The structure of the bottom plate has two holes for the placing of lightning fixtures, while the structure of the top plate does not have holes. Each piece also possesses a top structure in its superior part, which serves as a hook to other roof pieces (20), like mouth-and-tongue, and is characterized because its possesses a similar dimension to the plate underneath, with an transversal area which includes a central trough and elevated unequal quadrangular borders, one lesser than the other, which serves for the hitching of one top structure from another roof piece (20).

### Prototype

In order to realize the actual invention, a prototype was constructed that served to define the function details which brought conclusions which led to this invention unit.

1. Modular constructive system based in universal interconnecting pieces comprising:
at least one standard wall (1) which presents an incorporated fixed and predetermined electrical circuit in the wall, with its respective lateral electrical connection links (5) and wall-roof electrical connection links (7) in positions common to each wall of the construction system and on a plumbing circuit also incorporated in a fixed and predetermined manner in the wall and with its respective lateral water connection links (6);
at least one standard connector (12) formed by a hollow tubular structure of square cross sectional area, with guide elements (12C) in “C” shape on each face, at its interior it has an electrical circuit with its respective electrical connection points (12A), as well as connection points (12B), and free passes for piping, and associated at a “C” channel(13) for coupling which fastens the wall between its free ends on one side, and which hooks in the guide elements (12C) of the connector through its respective rails in “T” shape (13C), besides provided of superior (13A) and inferior(13B) openings for the free pass of the connection links; and, of
at least one roof piece (15) conformed by one superior structure (15A) which contains the electrical wiring network and which gives the roof its shape, an inferior cover plate (15B) which will function as the ceiling, and has electrical connection links (16) and openings (17) for the positioning of lightning fixtures, a top cover plate (15C) or flat support plate, and one top structure (15D) which serves as links between the roof pieces;
Characterized By:
the electrical wiring circuit incorporated in a predetermined manner in each one of the walls (1) of the constructive system, allows the match between the walls, and the electrical connection depends on the electrical connection links (5) of the wall (1) and of the electrical connection points (12A) arranged in the respective face of the connector (12) and which pass through the top opening (13A) in the “C” channel, once two walls have been elevated vertically and both the connector (12) and the “C” channel(13) have been put in coupling position with respect to these walls;
the plumbing circuit is also incorporated in a predetermined and common position all of the walls system, in a way which also permits the match between the walls, and where the plumbing connections depend on the connection between the connection links (6) and on the connection points (12B) for the laying of the plumbing network, which passes through the inferior opening (13B) in the “C” channel, once the walls (1), the connector(2) and the channel (13) are in position ; and,
the predetermined incorporated plumbing layout, in the same position in each wall (1) of the constructive system in such a way that it also permits the coincidence between walls, is connected through the lateral water connection links(6) with the connection points (12b) the connector (12), passing through the inferior opening (13b) of the channel (13), for the preparation of the plumbing layout in the constructive system.

2. Modular constructive system based in universal interconnecting pieces, according to claim 1, characterized because one of the principal faces of each wall (1) has a bypass box (10) for the electrical wiring circuit and its respective switch/plug (4).

3. Modular constructive system based in universal interconnecting pieces, according to claim 1, characterized because one of the principal faces of each wall (1) has water outlet points (11).

4. Modular constructive system based in universal interconnecting pieces, according to claim 1, characterized because on each wall (1) there are spaces for doors (3) and windows (2) for constructive system.

5. Modular constructive system based in universal interconnecting pieces, according claim 1, characterized because the walls (1) vertically risen and fastened through connectors (12) and channels (13) which have been put in coupling position with respect to these walls, rest on these fastening channels (9) for walls, which are bolted in for fixing.

6. Modular constructive system based in universal interconnecting pieces, according to claim 1, characterized because the connector (12) has associated also, a cosmetic cover (14) which hooks to the guide elements (12C) of the unused side of the connector (12), through a pair of channels (13c) in form of rails in “T” layed in the cosmetic cover(14).

7. Modular constructive system based in universal interconnecting pieces, according to claim 1, characterized because the cross sectional area of the top structure (15D), of the roof piece (15), presents a central trough and elevated quadrangular extremes of different sizes, such that one extreme fits in the other extreme of the adjacent wall.
